(19) United States
(12) Patent Application Publication
(10) Pub. No.: US 2026/0271881 A1
(43) Pub. Date: Sep. 17, 2026

(54) BARK STOPPING METHOD AND BARK STOPPING DEVICE

(71) Applicant: Guangdong Cool Technlogy Co., Ltd., Yangjiang (CN)

(72) Inventor: Mingya Li, Shenzhen (CN)

(21) Appl. No.: 19/674,148

(22) Filed: May 12, 2026

Related U.S. Application Data
(63) Continuation-in-part of application No. 18/946,070, filed on Nov. 13, 2024, now Pat. No. 12,642,249.

(30) Foreign Application Priority Data
Aug. 15, 2024 (CN) 2024111250076

(51) Int. Cl. A01K 15/02; G10L 17/26; G10L 25/78

(52) U.S. Cl. CPC A01K 15/022; G10L 17/26; G10L 25/78

(57) ABSTRACT

Disclosed are a bark stopping method and a bark stopping device, which relate to the technical field of pet equipment. After a barking sound of a dog is identified, a repellent sound wave is emitted toward the dog for a first preset duration, and then the emission of the repellent sound wave is stopped and whether a barking sound exists within a subsequent first preset time period is judged. If the barking sound exists within the first preset time period, whether a frequency of the repellent sound wave has crossed a preset first threshold is judged, and if the frequency of the repellent sound wave has not crossed the preset first threshold, the frequency of the repellent sound wave is adjusted according to a preset rule, and the repellent sound wave is emitted toward the dog again for a second preset duration.

### CROSS REFERENCE TO RELATED APPLICATION

The present application is a continuation-in-part of U.S. non-provisional application Ser. No. 18/946,070, which is filed on Nov. 13, 2024, and claims priority to the Chinese Patent Application No. 202411125007.6, filed on Aug. 15, 2024. The disclosures of the applications are incorporated in this application by reference in their entirety.

### FIELD OF THE APPLICATION

The present application relates to the technical field of pet equipment, and particularly to a bark stopping method and a bark stopping device.

### BACKGROUND OF THE APPLICATION

Pet dogs have always been loyal partners of human beings, accompanying many people's lives, and even guide dogs have entered the field of assisting human life. The present application mainly aims at the field of pet dogs, and there are many kinds of pet dogs, comprising Maltese dogs, Husky dogs, Poodle dogs, and the like. These pets are good companions when they are quiet, but the pet dogs are also sensitive animals, and sometimes they cannot help their nature. Their bark often interferes with people's normal life and disturbs residents.

The patent number CN112825790B discloses a bark identifying and stopping method and device and a bark stopper, wherein the bark is stopped by releasing aroma to drive the dog after acquiring a dog barking sound, which achieves an obvious effect, but users need to add the aroma regularly, and the bark cannot be stopped if the aroma is insufficient, which is not conducive to long-term use, and too much aroma will diffuse in the surrounding environment, which has a negative impact on the olfactory sensation of the dog and is not conducive to the normal life of the dog.

Therefore, it is necessary to provide a bark stopping method and a barking stopping device to stop the bark of the barking dog, thus facilitating long-term use by a user without having a negative impact on the olfactory sensation of the dog.

### SUMMARY OF THE APPLICATION

In order to solve the above problem, the present application provides a bark stopping method and a barking stopping device to stop the bark of the barking dog, thus facilitating long-term use by a user without having a negative impact on the olfactory sensation of the dog.

The technical scheme adopted in the present application is as follows:
the present application provides a bark stopping method, including operations of:
identifying a barking sound of a dog in a current environment;
emitting a repellent sound wave toward the dog when a bark stopping device executing the bark stopping method is in a first mode;
stopping emission of the repellent sound wave upon expiration of a first preset duration;
judging whether a barking sound exists within a subsequent first preset time period;
if the barking sound exists within the first preset time period, judging whether a frequency of the repellent sound wave has crossed a preset first threshold;
if the frequency of the repellent sound wave has not crossed the preset first threshold, increasing the frequency of the repellent sound wave according to a preset rule; continuing to emit the repellent sound wave toward the dog, and stopping emission of the repellent sound wave upon expiration of a second preset duration.

In an embodiment, in the operation of emitting the repellent sound wave toward the dog when the bark stopping device is in the first mode, the frequency of the repellent sound wave is consistent with a frequency of a repellent sound wave last emitted by the bark stopping device prior to a previous power-off or standby of the bark stopping device.

In an embodiment, in the operation of emitting the repellent sound wave toward the dog when the bark stopping device is in the first mode, a frequency of the repellent sound wave is identical to a frequency of the barking sound.

In an embodiment, a type of the dog is identified according to the barking sound in combination with a pre-stored sound model, and the frequency of the barking sound is obtained according to the type of the dog and the barking sound.

In an embodiment, prior to emitting the repellent sound wave after each barking sound detection, a distance of the dog is determined, whether the distance of the dog is less than a preset distance is judged, and the repellent sound wave is emitted only when the distance of the barking dog is less than the preset distance.

In an embodiment, the bark stopping method further includes:
if no barking sound exists within the first preset time period, judging whether a barking sound exists within a subsequent second preset time period;
if the barking sound exists within the second preset time period, emitting the repellent sound wave again, stopping emission of the repellent sound wave upon expiration of a third preset duration, and returning to the operation of judging whether the barking sound exists within the first preset time period.

In an embodiment, the bark stopping method further includes:
if the frequency of the repellent sound wave has crossed the preset first threshold, setting the frequency of the repellent sound wave to a preset second threshold;
emitting the repellent sound wave toward the dog and turning on a warning light;
stopping emission of the repellent sound wave and turning off the warning light upon expiration of a fourth preset duration.

In an embodiment, the bark stopping method further includes:
after stopping emission of the repellent sound waves and turning off the warning light, judging whether a barking sound exists within a subsequent third preset time period;
if the barking sound exists within the third preset time period, increasing the frequency of the repellent sound wave according to the preset rule;
judging whether the frequency of the repellent sound wave has crossed the preset first threshold;
if the frequency of the repellent sound wave has crossed the preset first threshold, setting the frequency of the repellent sound wave to the preset second threshold, emitting the repellent sound wave, and returning to the operation of stopping emission of the repellent sound wave upon expiration of the first preset duration.

In an embodiment, the bark stopping method further includes:
returning to the operation of emitting the repellent sound wave toward the dog and turning on the warning light after the operations of stopping emission of the repellent sound wave, turning off the warning light, and determining that the frequency of the repellent sound wave has not crossed the preset first threshold.

In an embodiment, the bark stopping method further includes:
if no barking sound exists within the third preset time period, judging whether a barking sound exists within a subsequent fourth preset time period; and
if the barking sound exists within the fourth preset time period, emitting the repellent sound wave again, turning on the warning light, stopping emission of the repellent sound wave and turning off the warning light upon expiration of a fifth preset duration.

In an embodiment, the bark stopping method further includes:
after emission of the repellent sound wave is stopped and the warning light is turned off upon expiration of the fifth preset duration, judging whether a barking sound exists within a subsequent fifth preset time period; and
emitting the repellent sound wave toward the dog and returning to the operation of stopping emission of the repellent sound wave upon expiration of the first preset duration.

In an embodiment, the bark stopping method further includes:
if no barking sound exists in the second preset time period, the fourth preset time period or the fifth preset time period, controlling the bark stopping device to enter a standby state.

In an embodiment, the bark stopping method further includes:
emitting a repellent sound wave with a preset frequency toward the dog when the current mode is a second mode, and stopping emission of the repellent sound wave upon expiration of a sixth preset duration;
judging whether a barking sound exists within a subsequent sixth preset time period; and
if the barking sound exists within the sixth preset time period, emitting the repellent sound wave toward the dog, and stopping emission upon expiration of a seventh preset duration, the seventh preset duration being longer than the sixth preset duration.

In an embodiment, the bark stopping method further includes:
judging whether a barking sound exists within a subsequent seventh preset time period;
if the barking sound exists within the seventh preset time period, emitting the repellent sound wave toward the dog and turning on the warning light, and stopping emission of the repellent sound wave and turning off the warning light upon expiration of an eighth preset duration.

In an embodiment, the bark stopping method further includes:
judging whether a barking sound exists within a subsequent eighth preset time period;
if the barking sound exists within the eighth preset time period, returning to the operation of emitting the repellent sound wave with the preset frequency toward the dog when the current mode is the second mode, and stopping emission of the repellent sound wave upon expiration of the sixth preset duration.

In an embodiment, the bark stopping method further includes:
if no barking sound exists in the sixth preset time period, the seventh preset time period or the eighth preset time period, controlling the bark stopping device to enter a standby state.

A bark stopping device is also provided and includes:
a shell;
a circuit board disposed inside the shell;
a power-on/off and mode selection module configured for power switching and mode selection;
a sound collecting module configured to collect environmental sound waves;
a sound wave emitting module configured to emit repellent sound waves;
a warning light; and
a processing module in communication connection with the power-on/off and mode selection module, the sound collecting module, the sound wave emitting module and the warning light; wherein the processing module is configured to receive signals output by the sound collecting module and the power-on/off and mode selection module, and invoke program codes to control the sound wave emitting module and the warning light, to implement the bark stopping method according to claim 1.

In an embodiment, the bark stopping device further includes a display module and a distance detecting module both in communication connection with the processing module, wherein the display module is configured to display a current operating mode and/or a frequency of a current repellent sound wave, and the distance detecting module is configured to detect a distance of the dog.

The present application has the beneficial effects as follows:
according to the bark stopping method and the bark stopping device provided by the present application, after each emission stops, if the bark stopping device still receives a barking sound within the first preset time period, the frequency of the repellent sound wave is increased. In this way, the frequency of the repellent sound wave is gradually increased to determine the optimal frequency for repelling the dog. If no barking sound exists, the emission of the repellent sound wave is stopped, and the bark is successfully stopped at this time. In conclusion, the barking stopping method and the barking stopping device can stop the bark of the dog, thus facilitating long-term use by a user without having a negative impact on the olfactory sensation of the dog.

### BRIEF DESCRIPTION OF THE DRAWINGS

FIG. 1 is a flow chart of a bark stopping method according to a first embodiment of the present application.

FIG. 2 shows a few more operations of the bark stopping method of FIG. 1.

FIG. 3 is a flow chart of detailed operations of operation S193 of the bark stopping method of FIG. 2.

FIG. 4 is a flow chart of detailed operations of operation S194 of the bark stopping method of FIG. 2.

FIG. 5 is a flow chart of detailed operations of operation S15 of the bark stopping method of FIG. 1.

FIG. 6 is a block diagram of modules in a circuit board of a bark stopping device according to a second embodiment of the present application.

FIG. 7 is an overall diagram of the bark stopping device according to the second embodiment of the present application.

FIGS. 8A, 8B and 9 are related to a bark stopping method according to a third embodiment of the present application.

FIG. 10 is a three-dimensional schematic view of a bark stopping device according to a fourth embodiment of the present application.

FIG. 11 is a block diagram of modules mounted on or connected to a circuit board of the bark stopping device of FIG. 10.

### DETAILED DESCRIPTION OF SOME EMBODIMENTS

In order to describe the technical solution of the present application more clearly and completely, the present application is further described hereinafter with reference to the drawings.

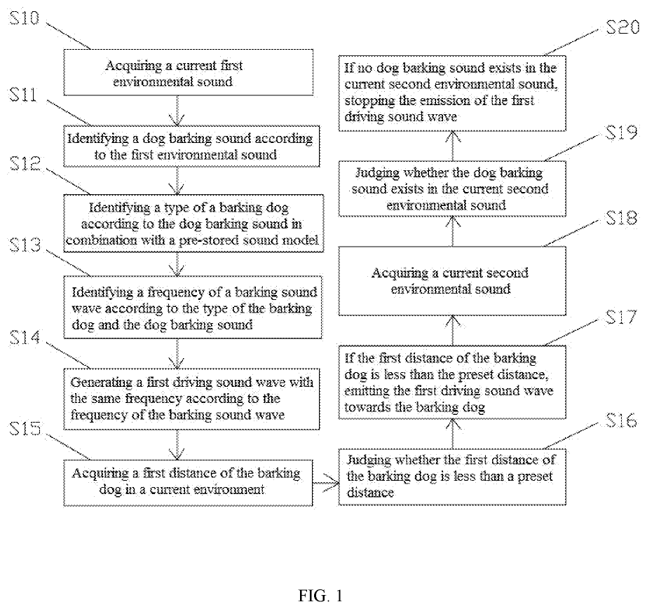

With reference to FIG. 1 to FIG. 6, the present application provides a bark stopping method, which includes the following steps;

S10: acquiring a current first environmental sound;

S11: identifying a dog barking sound according to the first environmental sound;

S12: identifying a type of a barking dog according to the dog barking sound in combination with a pre-stored sound model;

S13: identifying a frequency of a barking sound wave according to the type of the barking dog and the dog barking sound;

S14: generating a first driving sound wave with the same frequency according to the frequency of the barking sound wave;

S15: acquiring a first distance of the barking dog in a current environment;

S16: judging whether the first distance of the barking dog is less than a preset distance;

S17: if the first distance of the barking dog is less than the preset distance, emitting the first driving sound wave towards the barking dog;

S18: acquiring a current second environmental sound;

S19: judging whether the dog barking sound exists in the current second environmental sound; and

S20: if no dog barking sound exists in the current second environmental sound, stopping the emission of the first driving sound wave.

In this embodiment, the current first environmental sound is acquired, and the first environmental sound refers to all surrounding sounds; the dog barking sound is identified according to the first environmental sound, and if a sound in the first environmental sound conforms to the frequency of the dog barking sound, the dog barking sound is separately distinguished and marked as the dog barking sound; the type of the barking dog is identified according to the dog barking sound in combination with the pre-stored sound model, barking sounds of different dogs have different timbres and frequencies, and the pre-stored sound model stores barking sounds of various dogs; the frequency of the barking sound wave is identified according to the type of the barking dog and the dog barking sound, and barking sound waves of different dogs have different frequencies, so that the frequency of the barking sound wave may be quickly and accurately identified according to the type of the barking dog; the first driving sound wave with the same frequency is generated according to the frequency of the barking sound wave, and the first driving sound wave may be an ultrasonic wave or a processed dog barking sound, for example, if a current barking frequency of a Poodle dog is 16 KHz, a first driving sound wave of 16 KHz is generated; the first distance of the barking dog in the current environment is acquired, for example, if the current distance of the barking dog is 6 m, the first distance is 6 m; whether the first distance of the barking dog is less than the preset distance is judged, for example, if the preset distance is 7 m and the first distance is 6 m, the first distance is less than the preset distance; if the first distance of the barking dog is less than the preset distance, the first driving sound wave is emitted towards the barking dog, that is, the first driving sound wave of 16 KHz is emitted to drive the barking dog; the current second environmental sound is acquired, and the second environmental sound refers to all surrounding sounds within a period of time after the first driving sound wave is emitted; whether the dog barking sound exists in the current second environmental sound is judged, that is, after acquiring the environmental sound, whether the dog barking sound exists is judged; and if no dog barking sound exists in the current second environmental sound, the emission of the first driving sound wave is stopped, which indicates that the dog has stopped barking, so that the bark is successfully stopped.

In the whole bark stopping process, after acquiring the first environmental sound and identifying the dog barking sound, the type of the barking dog is identified, then the frequency of the barking sound wave is identified, and then the first driving sound wave with the same frequency is generated, and after acquiring the first distance, if the first distance is less than the preset distance, the first driving sound wave is emitted towards the barking dog to acquire the current second environmental sound, and if no barking sound exists in the second environmental sound, the emission of the first driving sound wave is stopped, and the bark is successfully stopped at this time.

In conclusion, the barking stopping method and the barking stopping device can stop the bark of the barking dog, thus facilitating long-term use by a user without having a negative impact on the olfactory sensation of the dog.

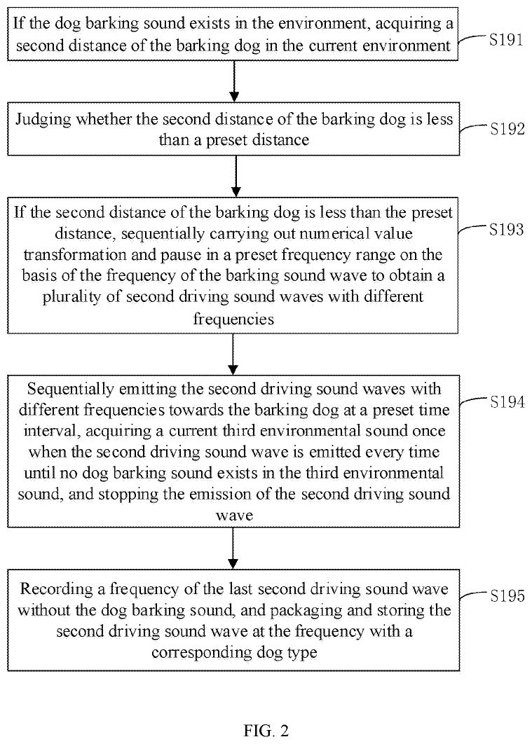

In this embodiment, referring to FIG. 2, the bark stopping method further includes:

S191: if the dog barking sound exists in the environment, acquiring a second distance of the barking dog in the current environment;

S192: judging whether the second distance of the barking dog is less than a preset distance;

S193: if the second distance of the barking dog is less than the preset distance, sequentially carrying out numerical value transformation and pause in a preset frequency range on the basis of the frequency of the barking sound wave to obtain a plurality of second driving sound waves with different frequencies;

S194: sequentially emitting the second driving sound waves with different frequencies towards the barking dog at a preset time interval, acquiring a current third environmental sound once when the second driving sound wave is emitted every time until no dog barking sound exists in the third environmental sound, and stopping the emission of the second driving sound wave; and

S195: recording a frequency of the last second driving sound wave without the dog barking sound, and packaging and storing the second driving sound wave at the frequency with a corresponding dog type.

In this embodiment, if the barking dog is still barking after the first driving sound wave is emitted, that is, the dog barking sound exists in the current second environmental sound, the second distance of the barking dog in the current environment is acquired in the same way as the first distance; whether the second distance of the barking dog is less than the preset distance is judged, for example, if the current distance of the barking dog is 6.5 m, the second distance is 6.5 m, and if the preset distance is 7 m, the second distance is less than the preset distance; if the second distance of the barking dog is less than the preset distance, the numerical value transformation and pause are sequentially carried out in the preset frequency range on the basis of the frequency of the barking sound wave to obtain the plurality of second driving sound waves with different frequencies, for example, if the barking sound wave frequency is 16 KHz and the preset frequency range is 15~30 KHz, the numerical value transformation and pause are sequentially carried out in a range of 16~30 KHz to obtain second driving sound waves of 16.5 KHz, 17 KHz, 17.5 KHz and the like up to 30 kHz; the second driving sound waves with different frequencies are sequentially emitted towards the barking dog at the preset time interval, the current third environmental sound is acquired once when the second driving sound wave is emitted every time until no dog barking sound exists in the third environmental sound, and the emission of the second driving sound wave is stopped, for example, after the second driving sound wave of 16.5 KHz is emitted, the current third environmental sound is acquired, if the dog barking sound exists, after the second driving sound wave of 17 KHz is emitted, the current third environmental sound is acquired, and if the dog barking sound still exists, after the second driving sound wave of 17.5 KHz is emitted, the current third environmental sound is acquired, and if no dog barking sound exists at this time, the emission of the second driving sound wave is stopped; and the frequency of the last second driving sound wave without the dog barking sound is recorded, and the second driving sound wave at the frequency is packaged and stored with the corresponding dog type, for example, if the Poodle dog is barking, after the second driving sound wave of 17.5 KHz is emitted, the dog barking sound is stopped, the second driving sound wave of 17.5 KHz is recorded, and packaged and stored with the type of the Poodle dog, and when the Poodle dog barks the next time, the second driving sound wave of 17.5 KHz is directly emitted.

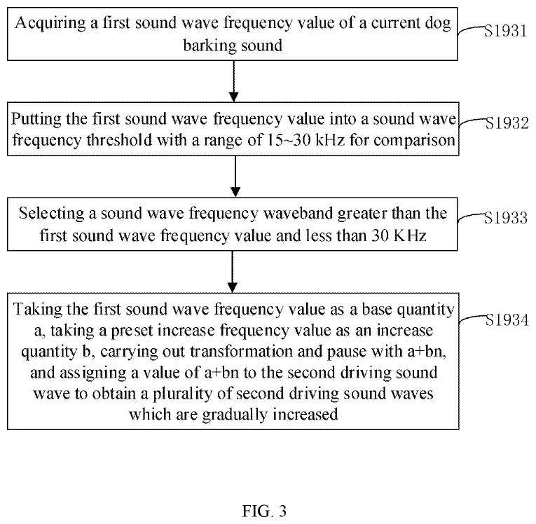

In this embodiment, referring to FIG. 3, the step of sequentially carrying out the numerical value transformation and pause in the preset frequency range on the basis of the frequency of the barking sound wave to obtain the plurality of second driving sound waves with different frequencies, includes:

S1931: acquiring a first sound wave frequency value of a current dog barking sound;

S1932: putting the first sound wave frequency value into a sound wave frequency threshold with a range of 15~30 kHz for comparison;

S1933: selecting a sound wave frequency waveband greater than the first sound wave frequency value and less than 30 KHz; and

S1934: taking the first sound wave frequency value as a base quantity a, taking a preset increase frequency value as an increase quantity b, carrying out transformation and pause with a+bn, and assigning a value of a+bn to the second driving sound wave to obtain a plurality of second driving sound waves which are gradually increased, wherein n>0, and a, b and n are all positive integers.

In this embodiment, the first sound wave frequency value of the current dog barking sound is acquired, and the frequency of the barking sound wave is identified according to the type of the barking dog and the dog barking sound, and the first sound wave frequency value is acquired, for example, the acquired first sound wave frequency value is 18 KHz; the first sound wave frequency value is put into the sound wave frequency threshold with the range of 15~30 KHz for comparison, for example, if the first sound wave frequency value is 18 KHz, the 18 KHz is put into the sound wave frequency threshold with the range of 15~30 KHz for comparison; the sound wave frequency waveband greater than the first sound wave frequency value and less than 30 KHz is selected, for example, the sound wave frequency threshold of 18~30 KHz is selected; and the first sound wave frequency value is taken as the base quantity a, the preset increase frequency value is taken as the increase quantity b, transformation and pause are carried out with a+bn, and the value of a+bn is assigned to the second driving sound wave to obtain the plurality of second driving sound waves which are gradually increased, wherein n >0, and a, b and n are all positive integers, for example, if a is 18 KHz and b is 0.5 KHz, the second driving sound wave emitted for the first time is 18.5 KHz, the second driving sound wave emitted for the second time is 19 KHz, and the third driving sound wave emitted for the third time is 19.5 KHz.

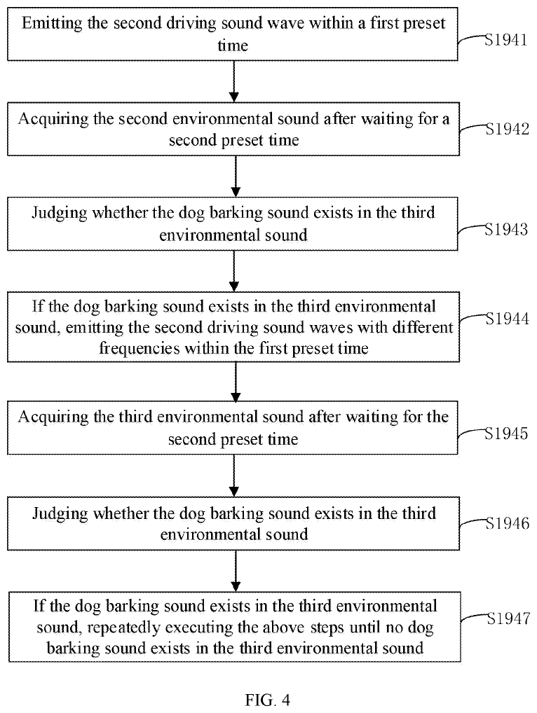

In this embodiment, referring to FIG. 4, the step of sequentially emitting the second driving sound waves with different frequencies towards the barking dog at the preset time interval, and acquiring the current third environmental sound once when the second driving sound wave is emitted every time until no dog barking sound exists in the third environmental sound, includes:

S1941: emitting the second driving sound wave within a first preset time;

S1942: acquiring the second environmental sound after waiting for a second preset time;

S1943: judging whether the dog barking sound exists in the third environmental sound; and

S1944: if the dog barking sound exists in the third environmental sound, emitting the second driving sound waves with different frequencies within the first preset time;

S1945: acquiring the third environmental sound after waiting for the second preset time;

S1946: judging whether the dog barking sound exists in the third environmental sound; and

S1947: if the dog barking sound exists in the third environmental sound, repeatedly executing the above steps until no dog barking sound exists in the third environmental sound.

In this embodiment, the second driving sound wave is emitted within the first preset time, for example, the second driving sound wave is emitted within 3 seconds, that is, the second driving sound wave is continuously transmitted for 3 seconds; the second environmental sound is acquired after waiting for the second preset time, for example, the second environmental sound is acquired after waiting for 2 seconds; whether the dog barking sound exists in the third environmental sound is judged; if the dog barking sound exists in the third environmental sound, the second driving sound waves with different frequencies are emitted within the first preset time, for example, if the second driving sound wave of 18 KHz is emitted last time, the second driving sound wave of 18.5 KHz is emitted this time; the third environmental sound is acquired after waiting for the second preset time, for example, the third environmental sound is acquired after waiting for 2 seconds; and whether the dog barking sound exists in the third environmental sound is judged; if the dog barking sound exists in the third environmental sound, the above steps are repeatedly executed until no dog barking sound exists in the third environmental sound, for example, if the dog barking sound still exists after the second driving sound wave of 18.5 KHz is emitted last time, the second driving sound wave of 19 KHz is emitted, and if the dog barking sound still exists in the acquired third environmental sound, the second driving sound wave of 19.5 KHz is emitted until no dog barking sound exists in the third environmental sound, wherein an upper limit of the second driving sound wave is 30 KHz.

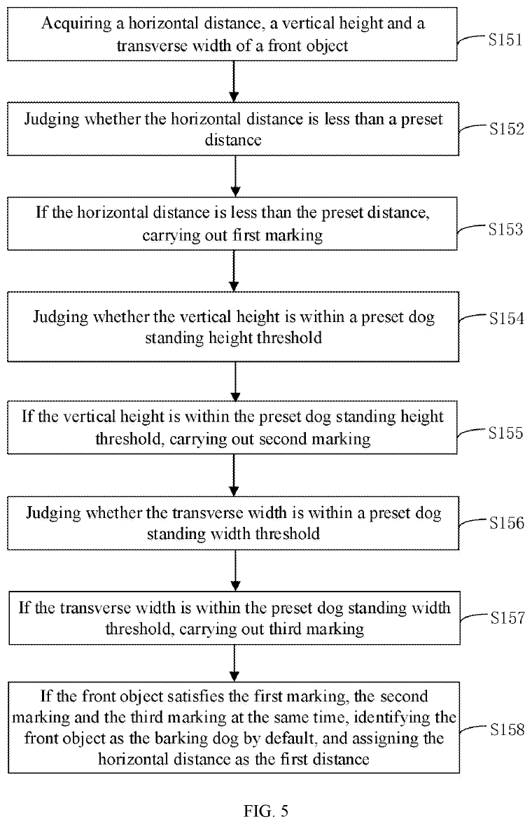

In this embodiment, referring to FIG. 5, the step of acquiring the first distance of the barking dog in the current environment, includes:

S151: acquiring a horizontal distance, a vertical height and a transverse width of a front object;

S152: judging whether the horizontal distance is less than a preset distance;

S153: if the horizontal distance is less than the preset distance, carrying out first marking;

S154: judging whether the vertical height is within a preset dog standing height threshold;

S155: if the vertical height is within the preset dog standing height threshold, carrying out second marking;

S156: judging whether the transverse width is within a preset dog standing width threshold;

S157: if the transverse width is within the preset dog standing width threshold, carrying out third marking; and

S158: if the front object satisfies the first marking, the second marking and the third marking at the same time, identifying the front object as the barking dog by default, and assigning the horizontal distance as the first distance.

In this embodiment, the horizontal distance, the vertical height and the transverse width of the front object are acquired; whether the horizontal distance is less than the preset distance is judged, for example, the present distance is 7 m; if the horizontal distance is less than the preset distance, first marking is carried out, for example, if the horizontal distance of the front object is 6 m and the preset distance is 7 m, the first marking is carried out on the front object; whether the vertical height is within the preset dog standing height threshold is judged, for example, the preset dog standing height threshold is 20~120 mm; if the vertical height is within the preset dog standing height threshold, second marking is carried out, for example, if the vertical height of the front object is 50 mm, the vertical height falls within 20 ~120 mm, and the second marking is carried out on the front object; whether the transverse width is within the preset dog standing width threshold is judged, for example, the preset dog standing width threshold is 15~150 mm, and this width covers front and side widths a dog, and is a broad value; if the transverse width is within the preset dog standing width threshold, third marking is carried out, for example, if the transverse width of the front object is 40 mm, the transverse width falls within 15~150 mm, and the third marking is carried out on the front object; and if the front object satisfies the first marking, the second marking and the third marking at the same time, the front object is identified as the barking dog by default, and the horizontal distance is assigned as the first distance.

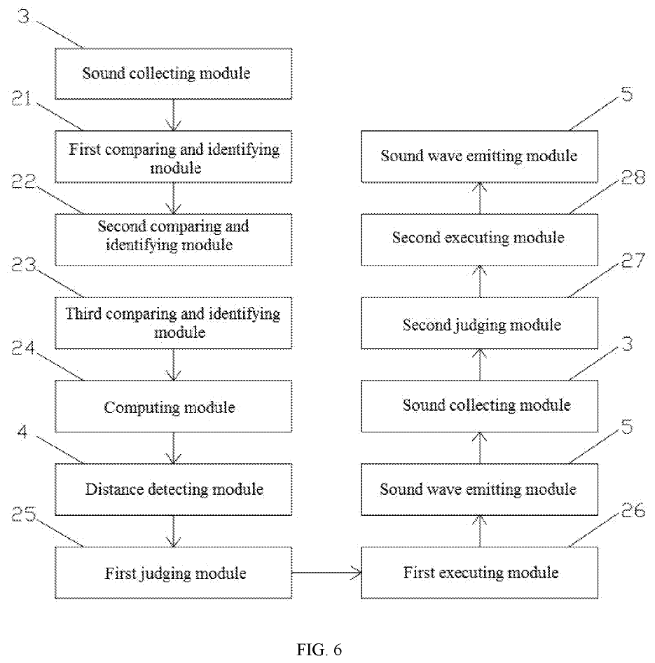

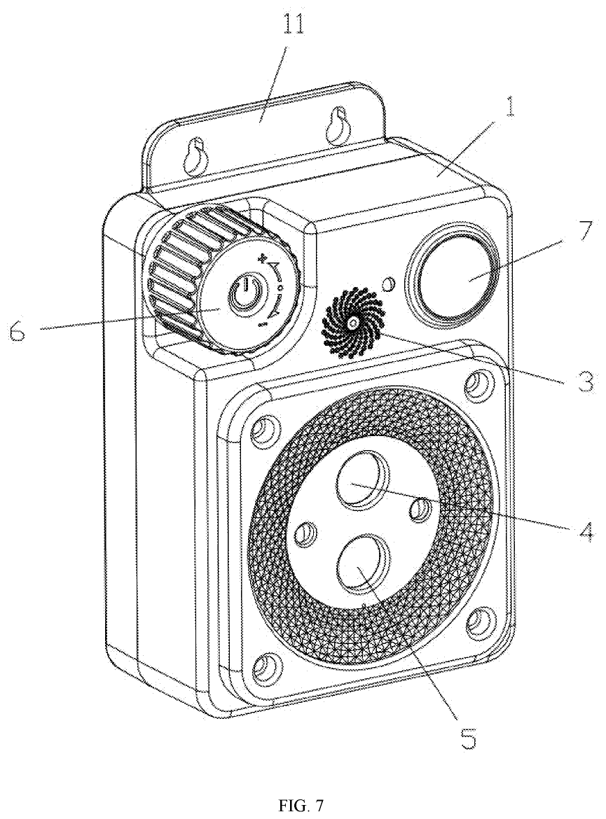

With reference to FIG. 6 and FIG. 7, a bark stopping device, according to the bark stopping method above, includes a shell 1, a circuit board, a sound collecting module 3, a distance detecting module 4 and a sound wave emitting module 5, wherein the circuit board is fixedly connected in the shell 1, one end of the shell 1 is provided with a hanging plate 11 for external fixation, the bark stopping device may be fixed on a wall or other vertical planes through the hanging plate 11, the sound collecting module 3, the distance detecting module 4 and the sound wave emitting module 5 are all fixedly connected to one side of the shell 1, the sound collecting module 3, the distance detecting module 4 and the sound wave emitting module 5 are all oriented to the outside, the sound collecting module 3, the distance detecting module 4 and the sound wave emitting module 5 are all electrically connected with the circuit board, and the circuit board is provided with a first comparing and identifying module 21, a second comparing and identifying module 22, a third comparing and identifying module 23, an computing module 24, a first judging module 25, a first executing module 26, a second judging module 27 and a second executing module 28.

The sound collecting module 3 is configured for acquiring the current first environmental sound, second environmental sound and third environmental sound.

The distance detecting module 4 is configured for acquiring the first distance and the second distance of the barking dog in the current environment.

The sound wave emitting module 5 is configured for emitting the first driving sound wave and the second driving sound wave towards the barking dog.

The first comparing and identifying module 21 is configured for identifying the dog barking sound according to the first environmental sound.

The second comparing and identifying module 22 is configured for identifying the type of the barking dog according to the dog barking sound in combination with the pre-stored sound model.

The third comparing and identifying module 23 is configured for identifying the frequency of the barking sound wave according to the type of the barking dog and the dog barking sound.

The computing module 24 is configured for generating the first driving sound wave with the same frequency according to the frequency of the barking sound wave.

The first judging module 25 is configured for judging whether the first distance of the barking dog is less than the preset distance.

The first executing module 26 is configured for, if the first distance of the barking dog is less than the preset distance, issuing an instruction to the sound wave emitting module 5, and emitting, by the sound wave emitting module 5, the first driving sound wave towards the barking dog.

The second judging module 27 is configured for judging whether the dog barking sound exists in the current second environmental sound.

The second executing module 28 is configured for, if no dog barking sound exists in the current second environmental sound, stopping the emission of the first driving sound wave.

In this embodiment, when the first environmental sound, the second environmental sound and the third environmental sound are acquired, the sound collecting module 3 is used for acquisition, the sound collecting module 3 is a microphone, the distance detecting module 4 may be an ultrasonic distance detecting module or an infrared distance detecting module, and the sound wave emitting module 5 may be an ultrasonic wave emitting module or a loudspeaker.

In this embodiment, the circuit board is further provided with a third executing module, a third judging module, a fourth executing module, an alternative executing module and a record storage module.

The third executing module is configured for, if the dog barking sound exists in the current second environmental sound, starting up the sound collecting module.

The third judging module configured for judging whether the second distance of the barking dog is less than the preset distance.

The fourth executing module is configured for, if the second distance of the barking dog is less than the preset distance, sequentially carrying out the numerical value transformation and pause in the preset frequency range on the basis of the frequency of the barking sound wave to obtain the plurality of second driving sound waves with different frequencies.

The alternative executing module is configured for sequentially emitting the second driving sound waves with different frequencies towards the barking dog at the preset time interval, acquiring the current third environmental sound once when the second driving sound wave is emitted every time until no dog barking sound exists in the third environmental sound, and stopping the emission of the second driving sound wave.

The record storage module is configured for recording the frequency of the last second driving sound wave without the dog barking sound, and packaging and storing the second driving sound wave at the frequency with the corresponding dog type.

In this embodiment, the bark stopping device further includes a distance detection and adjustment switch 6, the distance detection and adjustment switch 6 is fixedly connected to the shell 1, and the distance detection and adjustment switch 6 is electrically connected with the circuit board. The distance detection and adjustment switch 6 is used for adjusting a detection distance of the distance detecting module 4, for example, if the barking stopping device is mounted in a relatively empty place in surrounding environment, the original preset distance may be adjusted from 7 m to 10 m, that is, when the dog barks within 7 m, the bark stopping device will emit the driving sound wave, and after adjustment, when the dog barks within 10 m, the bark stopping device will emit the driving sound wave. The distance detection and adjustment switch 6 maybe a knob switch or a linear adjustment switch.

In this embodiment, the bark stopping device further includes a display screen 7, the display screen 7 is fixedly connected to one side of the shell 1, and the display screen 7 is electrically connected with the circuit board. The display screen 7 may display a distance of a current barking dog, and may also display a current time.

In this embodiment, the bark stopping device further includes a battery, the battery is fixedly connected inside the shell 1, and the battery is electrically connected with the circuit board. The battery is a lithium battery used to supply power to the bark stopping device, which is convenient for carrying the bark stopping device to the outside.

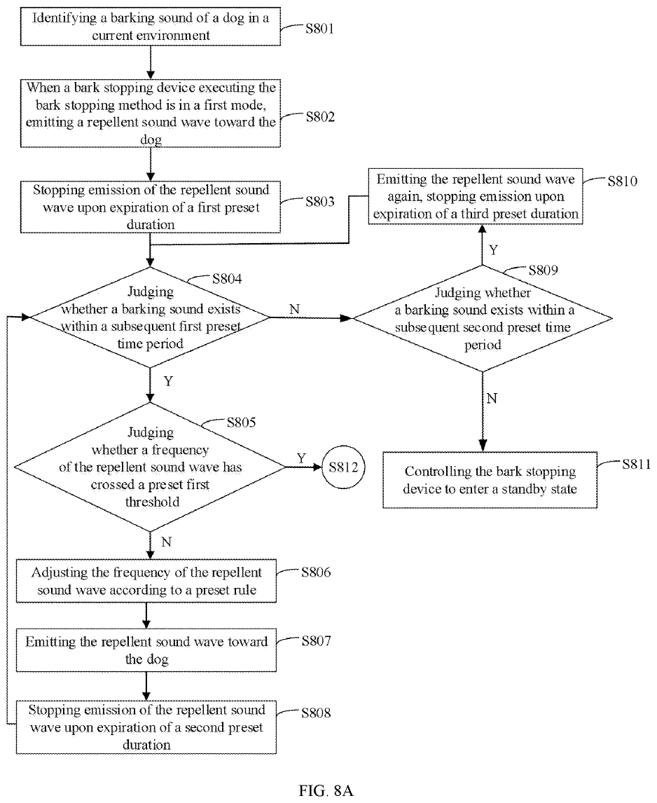

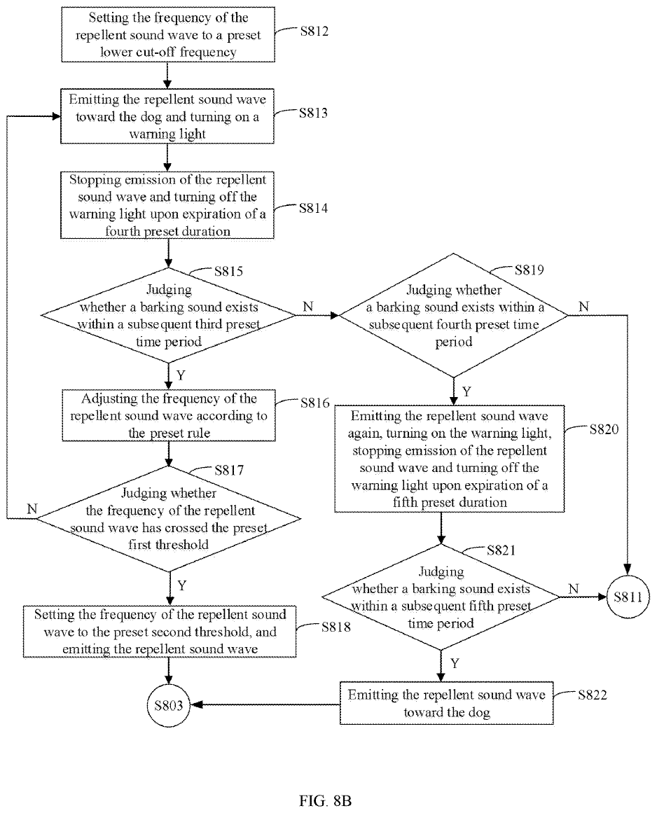

Referring to FIG. 8A and FIG. 8B, which are related to a bark stopping method in a third embodiment. The bark stopping method includes the following operations:

Operation S801: identifying a barking sound of a dog in a current environment;

Operation S802: when a bark stopping device executing the bark stopping method is in a first mode, emitting a repellent sound wave toward the dog, in one embodiment, a frequency of the repellent sound wave is consistent with a frequency of a repellent sound wave last emitted by the bark stopping device prior to its previous power-off or standby, for example, if the barking sound is first recognized after startup of the bark stopping device, the frequency of the repellent sound wave is the same as that of the last repellent sound wave emitted before the previous power-off; if the barking sound is sensed during device standby, the frequency of the repellent sound wave is consistent with the frequency of the last repellent sound wave before standby; in another embodiment, the frequency of the repellent sound wave is set to be identical to a frequency of the barking sound;

Operation S803: stopping emission of the repellent sound wave upon expiration of a first preset duration;

Operation S804: judging whether a barking sound exists within a subsequent first preset time period, and proceeding to Operation S805 if the barking sound exists within the first preset time period, or to Operation S809 if no barking sound exists within the first preset time period;

Operation S805: judging whether the frequency of the repellent sound wave has crossed a preset first threshold, and proceeding to Operation S806 if the frequency of the repellent sound wave has not crossed the preset first threshold, or to Operation S812 if the frequency of the repellent sound wave has crossed the preset first threshold;

Operation S806: adjusting the frequency of the repellent sound wave according to a preset rule, for example, the frequency of the repellent sound wave is increased by 1 KHz;

Operation S807: emitting the repellent sound wave toward the dog;

Operation S808: stopping emission of the repellent sound wave upon expiration of a second preset duration, and returning to Operation S804;

Operation S809: judging whether a barking sound exists within a subsequent second preset time period, and proceeding to Operation S810 if the barking sound exists within the second preset time period, or to Operation S811 if no barking sound exists within the second preset time period;

Operation S810: emitting the repellent sound wave again, stopping emission of the repellent sound wave upon expiration of a third preset duration, and returning to Operation S804;

Operation S811: controlling the bark stopping device to enter a standby state; in the present embodiment, if a barking sound is detected in the standby state, the method restarts from Operation S801;

Operation S812: setting the frequency of the repellent sound wave to a preset second threshold;

Operation S813: emitting the repellent sound wave toward the dog and turning on a warning light;

Operation S814: stopping emission of the repellent sound wave and turning off the warning light upon expiration of a fourth preset duration;

Operation S815: judging whether a barking sound exists within a subsequent third preset time period, and proceeding to Operation S816 if the barking sound exists within the third preset time period, or to Operation S819 if no barking sound exists within the third preset time period;

Operation S816: increasing the frequency of the repellent sound wave according to the preset rule, for example, the frequency of the repellent sound wave is increased or decreased by 1 KHz;

Operation S817: judging whether the frequency of the repellent sound wave has crossed the preset first threshold, and returning to Operation S813 if the frequency of the repellent sound wave has not crossed the preset first threshold, or proceeding to Operation S818 if the frequency of the repellent sound wave has crossed the preset first threshold;

Operation S818: setting the frequency of the repellent sound wave to the preset second threshold, emitting the repellent sound wave, and returning to Operation S803;

Operation S819: judging whether a barking sound exists within a subsequent fourth preset time period, and proceeding to Operation S820 if the barking sound exists within the fourth preset time period, or returning to Operation S811 if no barking sound exists within the fourth preset time period;

Operation S820: emitting the repellent sound wave again, turning on the warning light, stopping emission of the repellent sound wave and turning off the warning light upon expiration of a fifth preset duration;

Operation S821: judging whether a barking sound exists within a subsequent fifth preset time period, and proceeding to Operation S822 if the barking sound exists within the fifth preset time period, or returning to Operation S811 if no barking sound exists within the fifth preset time period; and

Operation S822: emitting the repellent sound wave toward the dog, and returning to Operation S803.

After each emission stops, if the bark stopping device still receives a barking sound within the first preset time period, the frequency of the repellent sound wave is adjusted (e.g., increased). In this way, the frequency of the repellent sound wave is gradually adjusted (e.g., increased) to determine the optimal frequency for repelling the dog. If the frequency of the repellent sound wave reaches or has crossed the maximum or minimum frequency, i.e., the preset first threshold, and the optimal frequency has not yet been determined, a warning light is activated to assist in dog repelling, so as to ensure a satisfactory repellent effect.

Once the dog is deterred, that is, no barking sound is detected within the first preset time period, the optimal frequency is stored. When barking is detected subsequently, the bark stopping device emits repellent sound waves at the recorded frequency for secondary deterrence. Accordingly, when frequent barking interference is generated by a specific nearby dog, after the optimal frequency for the dog is acquired and stored, the bark stopping device can directly adopt this verified optimal frequency for subsequent deterrence operations, which greatly improves overall repelling efficiency.

Each of the first preset duration, the second preset duration, the third preset duration, the fourth preset duration and the fifth preset duration may be equal to or different from one another, which is not limited herein.

In one embodiment, the preset first threshold is an upper threshold, and the preset second threshold is a lower threshold. The preset first threshold is greater than the preset second threshold. Adjusting the frequency of the repellent sound wave according to the preset rule includes: increasing the frequency of the repellent sound wave according to the preset rule. That the frequency of the repellent sound wave has crossed the preset first threshold means the frequency of the repellent sound wave exceeds the preset first threshold.

In another embodiment, the preset first threshold is the lower threshold, and the preset second threshold is the upper threshold. the preset first threshold is less than the preset second threshold. Adjusting the frequency of the repellent sound wave according to the preset rule includes: decreasing the frequency of the repellent sound wave according to the preset rule. That the frequency of the repellent sound wave has crossed the preset first threshold means the frequency of the repellent sound wave falls below the preset first threshold.

In one embodiment, prior to judging whether a barking sound exists within the second or fourth preset time period in Operations S809 and S819, the method further includes an operation of controlling the bark stopping device to enter the standby state.

Specific application scenarios are exemplified below.

### Scenario 1

A user selects the first mode via a knob equipped on the bark stopping device, a microphone of the bark stopping device is activated to start working, and a first barking sound is detected. An ultrasonic probe of the bark stopping device emits a 15 KHz ultrasonic wave, namely the repellent sound wave, for a duration of 4 seconds. If barking is detected again within 5 seconds after emission stops, the ultrasonic probe outputs a 16 KHz ultrasonic wave for another 4 seconds.

If no barking sound is detected within the 5-second period, 16 KHz is stored as the optimal frequency. If barking is newly detected again at the 6th second, the bark stopping device re-emits the 16 KHz ultrasonic wave for 4 seconds. If barking is still detected within 5 seconds after the end of emission, the ultrasonic frequency is further increased by 1 KHz for subsequent emission.

After device power-on or standby exit, an ultrasonic frequency adopted for first emission upon initial barking detection is set to be consistent with the frequency before the previous power-off or standby. For example, if the last ultrasonic frequency before power-off/standby is 20 KHz, the bark stopping device will emit a 20 KHz ultrasonic wave for 4 seconds when barking is detected after restart or during standby. If the barking stops, the 20 KHz frequency is retained and will be preferentially adopted for emission upon next barking detection. If the barking sound persist beyond 5 seconds, the bark stopping device emits a 21 KHz ultrasonic wave. If continuous barking is detected within 5 seconds after each subsequent ultrasonic emission, the emission frequency increases progressively until reaching the preset first threshold of 30 KHz.

### Scenario 2

The ultrasonic frequency stored prior to the last power-off is 29 KHz. If the first emission of a 29KHz ultrasonic wave after power-on fails to suppress barking, a 30 KHz ultrasonic wave is emitted instead.

If the 30 KHz ultrasonic wave also fails to suppress barking, the bark stopping device switches emission to the preset second threshold of 15 kHz, and activates the warning light. If the barking continues within 5 seconds, the bark stopping device continuously operates in a mode in which the ultrasonic frequency is increased by 1 KHz from the previous frequency level in each cycle, with the warning light activated synchronously.

If barking is detected again within 30 seconds after the aforesaid 5-second period, ultrasonic waves are emitted at the previous frequency while the warning light is turned on simultaneously. If no barking is detected within 30 seconds, the warning light is not activated. For example, the bark stopping device firstly outputs a 24 kHz ultrasonic wave with warning light; when barking recurs within 30 seconds after the 5-second duration, the 24 kHz ultrasonic wave combined with warning light is maintained. If barking recurs after the 30-second period (such as, recurs at the 31st second), the bark stopping device reverts to emitting only the 24 kHz ultrasonic wave without the warning light. The warning light will not be reactivated until the ultrasonic frequency is adjusted upward to the preset first threshold (that is, increased progressively from 24 kHz to 30 kHz) and still fails to suppress barking.

In one embodiment, a type of the dog is identified according to the barking sound in combination with a pre-stored sound model, and the frequency of the barking sound is obtained according to the type of the dog and the barking sound. Reference may be made to the above-mentioned first embodiment for details of how to obtain the frequency of the barking sound.

In one embodiment, prior to emitting the repellent sound wave after each barking sound detection, the bark stopping device determines whether a distance of the dog is less than a preset threshold. The repellent sound wave is emitted only when the distance of the dog is below the preset distance. The specific implementation for determining the distance of the dog may refer to the above-mentioned first embodiment.

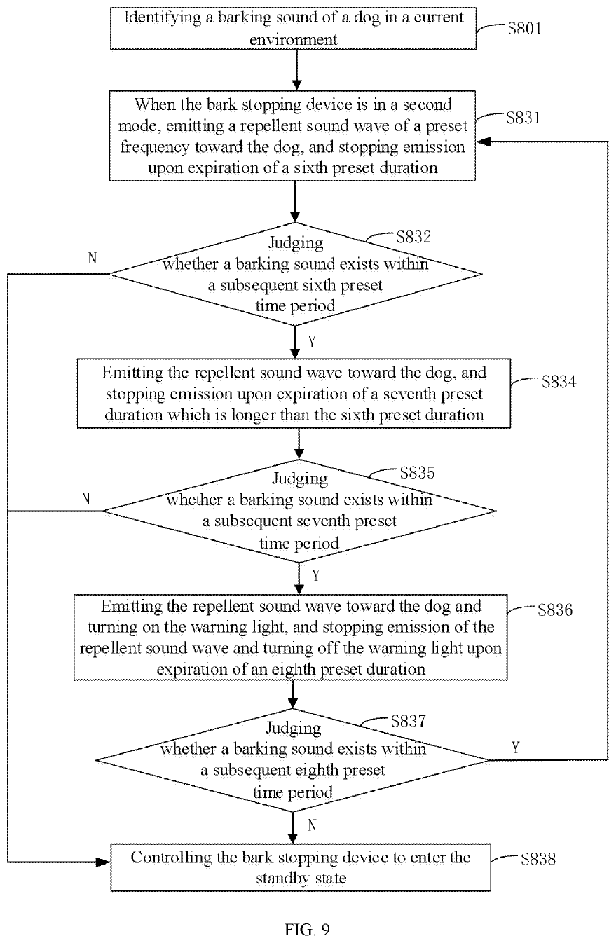

In one embodiment, referring to FIG. 9, the bark stopping method further includes the following operations:

Operation S831: when the bark stopping device is in a second mode, emitting a repellent sound wave of a preset frequency toward the dog, and stopping emission upon expiration of a sixth preset duration; in the second mode, all repellent sound waves emitted by the bark stopping device are of a same frequency;

Operation S832: judging whether a barking sound exists within a subsequent sixth preset time period, and proceeding to Operation S834 if the barking sound exists within the sixth preset time period, or to Operation S838 if no barking sound exists within the sixth preset time period;

Operation S834: emitting the repellent sound wave toward the dog, and stopping emission upon expiration of a seventh preset duration, the seventh preset duration being longer than the sixth preset duration;

Operation S835: judging whether a barking sound exists within a subsequent seventh preset time period, and proceeding to Operation S836 if the barking sound exists within the seventh preset time period, or to Operation S838 if no barking sound exists within the seventh preset time period;

Operation S836: emitting the repellent sound wave toward the dog and turning on the warning light, and stopping emission of the repellent sound wave and turning off the warning light upon expiration of an eighth preset duration; in one embodiment, the eighth preset duration is equal to the seventh preset duration; in other embodiments, the eighth preset duration is not equal to the seventh preset duration;

Operation S837: judging whether a barking sound exists within a subsequent eighth preset time period, and returning to Operation S831 if the barking sound exists within the eighth preset time period, or proceeding to Operation S838 if no barking sound exists within the eighth preset time period; and

Operation S838: controlling the bark stopping device to enter the standby state.

In this embodiment, if the first emission of the repellent sound wave fails to deter the dog effectively, the emission duration of the repellent sound wave is extended, and even the warning light is activated to achieve a reliable repellent effect.

In one embodiment, the bark stopping method further includes a third mode. The third mode operates similarly to the second mode, except that the two modes adopt different repellent sound wave frequencies. For instance, the repellent sound wave frequency is 25 KHz in the third mode and 15 KHz in the second mode.

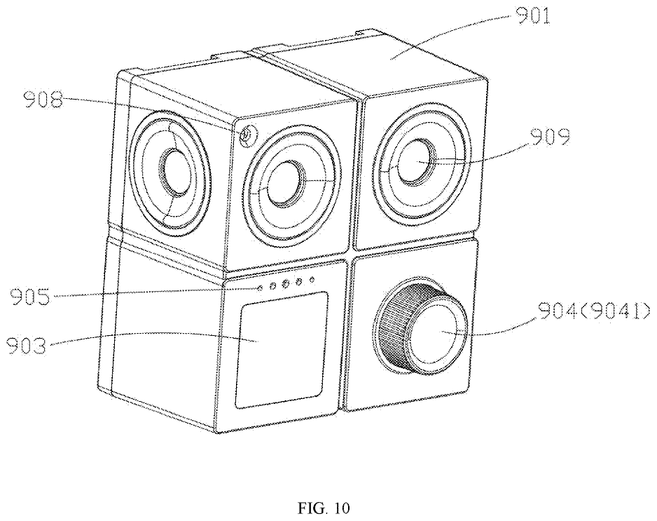

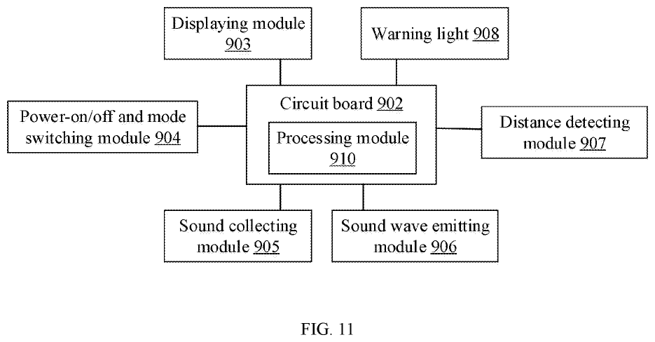

Referring to FIG. 10 and FIG. 11, FIG. 10 is a schematic perspective view of a bark stopping device in a fourth embodiment of the present application, and FIG. 11 is a schematic diagram showing modules installed on or connected to a circuit board inside the bark stopping device. The bark stopping device is configured to perform the bark stopping method of the third embodiment.

In this embodiment, the bark stopping device 9 includes a shell 901, a circuit board 902 disposed inside the shell 901, and a display module 903, a power-on/off and mode selection module 904, a sound collecting module 905, a sound wave emitting module 906, a distance detecting module 907 and a warning light 908. The foregoing components are mounted on the shell 901 and electrically connected to the circuit board 902. In this embodiment, the power-on/off and mode selection module 904 is configured as a knob 9041. A user may rotate the knob 9041 to realize power switching and selection among the first mode, the second mode and the third mode. The sound collecting module 905 is configured as a microphone 9051. The sound wave emitting module 906 and the distance detecting module 907 are each implemented by one or more ultrasonic probes 909. The display module 903 is configured to display a current working mode and/or a current repellent sound wave frequency during working.

A battery (not shown) and a processing module 910 are mounted on the circuit board 902. The processing module 910 is in communication connection with the display module 903, the power on/off and mode selection module 904, the sound collecting module 905, the sound wave emitting module 906, the distance detecting module 907 and the warning light 908. The processing module 910 may be a system on chip, or a combination of a processing chip (or a control chip), such as a micro-controlling unit (MCU), and a memory chip. The processing module 910 is configured to receive output signals from the sound collecting module 905, the distance detecting module 907 and the power-on/off and mode selection module 904, and run program codes to implement the bark stopping method of the third embodiment.

In the standby state, the sound collecting module 905 remains active for sound acquisition. Components, including the sound wave emitting module 906, the distance detecting module 907, the warning light 908 and the display screen are powered off, and the processing module 910 operates in a power-saving state via frequency scaling and voltage reduction to reduce overall power consumption.

Certainly, there are many other embodiments in the present application, and based on the embodiment, other embodiments obtained by those of ordinary skills in the art without going through any creative work are all within the scope of protection of the present application.

What is claimed is:

1. A bark stopping method, comprising operations of:
identifying a barking sound of a dog in a current environment;
emitting a repellent sound wave toward the dog when a bark stopping device executing the bark stopping method is in a first mode;
stopping emission of the repellent sound wave upon expiration of a first preset duration;
judging whether a barking sound exists within a subsequent first preset time period;
if the barking sound exists within the first preset time period, judging whether a frequency of the repellent sound wave has crossed a preset first threshold;
if the frequency of the repellent sound wave has not crossed the preset first threshold, adjusting the frequency of the repellent sound wave according to a preset rule; and
continuing to emit the repellent sound wave toward the dog, and stopping emission of the repellent sound wave upon expiration of a second preset duration.

2. The bark stopping method according to claim 1, wherein in the operation of emitting the repellent sound wave toward the dog when the bark stopping device is in the first mode, the frequency of the repellent sound wave is consistent with a frequency of a repellent sound wave last emitted by the bark stopping device prior to a previous power-off or standby of the bark stopping device.

3. The bark stopping method according to claim 1, wherein in the operation of emitting the repellent sound wave toward the dog when the bark stopping device is in the first mode, a frequency of the repellent sound wave is identical to a frequency of the barking sound.

4. The bark stopping method according to claim 3, wherein a type of the dog is identified according to the barking sound in combination with a pre-stored sound model, and the frequency of the barking sound is obtained according to the type of the dog and the barking sound.

5. The bark stopping method according to claim 1, prior to emitting the repellent sound wave after each barking sound detection, a distance of the dog is determined, whether the distance of the dog is less than a preset distance is judged, and the repellent sound wave is emitted only when the distance of the barking dog is less than the preset distance.

6. The bark stopping method according to claim 1, further comprising:
if no barking sound exists within the first preset time period, judging whether a barking sound exists within a subsequent second preset time period; and
if the barking sound exists within the second preset time period, emitting the repellent sound wave again, stopping emission of the repellent sound wave upon expiration of a third preset duration, and returning to the operation of judging whether the barking sound exists within the first preset time period.

7. The bark stopping method according to claim 6, further comprising:
if the frequency of the repellent sound wave has crossed the preset first threshold, setting the frequency of the repellent sound wave to a preset second threshold;
emitting the repellent sound wave toward the dog and turning on a warning light; and
stopping emission of the repellent sound wave and turning off the warning light upon expiration of a fourth preset duration.

8. The bark stopping method according to claim 7, further comprising:
after stopping emission of the repellent sound waves and turning off the warning light, judging whether a barking sound exists within a subsequent third preset time period;
if the barking sound exists within the third preset time period, increasing the frequency of the repellent sound wave according to the preset rule;
judging whether the frequency of the repellent sound wave has crossed the preset first threshold; and
if the frequency of the repellent sound wave has crossed the preset first threshold, setting the frequency of the repellent sound wave to the preset second threshold, emitting the repellent sound wave, and returning to the operation of stopping emission of the repellent sound wave upon expiration of the first preset duration.

9. The bark stopping method according to claim 8, further comprising:
returning to the operation of emitting the repellent sound wave toward the dog and turning on the warning light after the operations of stopping emission of the repellent sound wave, turning off the warning light, and determining that the frequency of the repellent sound wave has not crossed the preset first threshold.

10. The bark stopping method according to claim 9, further comprising:
if no barking sound exists within the third preset time period, judging whether a barking sound exists within a subsequent fourth preset time period; and
if the barking sound exists within the fourth preset time period, emitting the repellent sound wave again, turning on the warning light, stopping emission of the repellent sound wave and turning off the warning light upon expiration of a fifth preset duration.

11. The bark stopping method according to claim 10, further comprising:
after emission of the repellent sound wave is stopped and the warning light is turned off upon expiration of the fifth preset duration, judging whether a barking sound exists within a subsequent fifth preset time period; and
emitting the repellent sound wave toward the dog and returning to the operation of stopping emission of the repellent sound wave upon expiration of the first preset duration.

12. The bark stopping method according to claim 11, further comprising:
if no barking sound exists in the second preset time period, the fourth preset time period or the fifth preset time period, controlling the bark stopping device to enter a standby state.

13. The bark stopping method according to claim 1, further comprising:
emitting a repellent sound wave with a preset frequency toward the dog when the current mode is a second mode, and stopping emission of the repellent sound wave upon expiration of a sixth preset duration;
judging whether a barking sound exists within a subsequent sixth preset time period; and
if the barking sound exists within the sixth preset time period, emitting the repellent sound wave toward the dog, and stopping emission upon expiration of a seventh preset duration, the seventh preset duration being longer than the sixth preset duration.

14. The bark stopping method according to claim 13, further comprising:
judging whether a barking sound exists within a subsequent seventh preset time period; and
if the barking sound exists within the seventh preset time period, emitting the repellent sound wave toward the dog and turning on the warning light, and stopping emission of the repellent sound wave and turning off the warning light upon expiration of an eighth preset duration.

15. The bark stopping method according to claim 14, further comprising:
judging whether a barking sound exists within a subsequent eighth preset time period; and
if the barking sound exists within the eighth preset time period, returning to the operation of emitting the repellent sound wave with the preset frequency toward the dog when the current mode is the second mode, and stopping emission of the repellent sound wave upon expiration of the sixth preset duration.

16. The bark stopping method according to claim 15, further comprising:
if no barking sound exists in the sixth preset time period, the seventh preset time period or the eighth preset time period, controlling the bark stopping device to enter a standby state.

17. A bark stopping device, comprising:
a shell;
a circuit board disposed inside the shell;
a power-on/off and mode selection module configured for power switching and mode selection;
a sound collecting module configured to collect environmental sound waves;
a sound wave emitting module configured to emit repellent sound waves;
a warning light; and
a processing module in communication connection with the power-on/off and mode selection module, the sound collecting module, the sound wave emitting module and the warning light; wherein the processing module is configured to receive signals output by the sound collecting module and the power-on/off and mode selection module, and invoke program codes to control the sound wave emitting module and the warning light, to implement the bark stopping method according to claim 1.

18. The bark stopping device according to claim 17, further comprising a display module and a distance detecting module both in communication connection with the processing module, wherein the display module is configured to display a current operating mode and/or a frequency of a current repellent sound wave, and the distance detecting module is configured to detect a distance of the dog.
